(19) United States
(12) Patent Application Publication
(10) Pub. No.: US 2007/0245912 A1
(43) Pub. Date: Oct. 25, 2007

(54) PRINTING UNIT OF A REEL-FED PRESS

(75) Inventors: Norbert Dylla, Stadtbergen (DE); Thomas Boeck, Neusaess (DE); Thomas John, Augsburg (DE); Thomas Kandlbinder, Augsburg (DE)

Correspondence Address: CROWELL & MORING LLP;INTELLECTUAL PROPERTY GROUP, P.O. BOX 14300, WASHINGTON, DC, 20044-4300, US

(73) Assignee: MAN Roland Druckmaschinen AG, Augsburg (DE)

(21) Appl. No.: 11/738,397

(22) Filed: Apr. 20, 2007

(30) Foreign Application Priority Data
Apr. 21, 2006 (DE) 10 2006 018 526.9

(51) Int. Cl. B41F 7/02

(52) U.S. Cl. 101/217

(57) ABSTRACT

A printing unit of a rotary printing press with a transfer cylinder and a form cylinder interacting with the transfer cylinder is disclosed. The body length of the transfer cylinder and the form cylinder corresponds to six horizontal or upright print pages and the transfer cylinder has two channels offset by 180° in the circumferential direction to accommodate printing blankets. Two or three printing blankets are arranged next to one another in the longitudinal direction of the transfer cylinder. With the arrangement of two printing blankets, one printing blanket is twice as wide as the second printing blanket and the printing blankets each are attached in one of the two channels offset by 180°. With the arrangement of three printing blankets, two adjacent printing blankets are attached in a channel and the third printing blanket is attached in the offset channel.

This application claims the priority of German Patent Document No. 10 2006 018 526.9, filed Apr. 21, 2006, the disclosure of which is expressly incorporated by reference herein.

### BACKGROUND AND SUMMARY OF THE INVENTION

The invention relates to a printing unit of a reel-fed press.

With reel-fed presses, more preferably with multiple page wide reel-fed presses, as with 6-2 printing presses, bending vibrations of the rotary bodies frequently occur. These bending vibrations have a negative effect with regard to the printing process.

The bending vibrations on the one hand are caused through the increasing body length L. As a result, bending through dₘₐₓ already occurs because of the dead weight of the rotary body which is directly proportional to L³ or L⁴. This basic bending through already promotes the susceptibility to vibration of the rotary body. On the other hand, such bending vibrations are excited through the clamping channels which are provided on the rotary bodies for mounts. In this way, the rubber blanket plates and the printing plates are mounted on the transfer cylinder and the form cylinder respectively via the clamping channels. If the clamping channels of adjacent transfer cylinders and form cylinders now happen to meet with the printing press in operation, a lower resistance moment of the cylinders in contact favours a so-called channel knocking which in turn causes the excitation of the undesirable bending vibration(s).

From German Patent Document No. DE 100 66 162 B4 a six page wide printing unit is already known where the vibration behaviour is to be reduced through a certain arrangement of the mounts. Here, the transfer cylinder has two clamping channels to accommodate printing blankets which are arranged on the circumference offset by 180°. In the longitudinal direction of the transfer cylinder, three printing blankets are arranged next to one another, while each of the printing blankets is arranged in an alternating way, i.e. 0°-180°-0° or 180°-0°-180°. However, this special arrangement of the printing blankets reduces the vibration characteristics only insufficiently.

The inventors therefore set themselves the task of designing a printing unit of a reel-fed printing press such that the vibration behaviour is further reduced.

The inventors have recognized that the alternating arrangement of three printing blankets along the body length of the transfer cylinder, because of the symmetrical arrangement relative to the transfer cylinder center, still greatly promotes the vibration excitation. Moreover, the use of a double width rubber blanket for a super panorama print is not possible. The inventors have further recognized that the arrangement of three printing blankets with 0°-0°-180° or 180°-0°-0° and 180°-180°-0° or 0°-180°-180° offset has a positive effect on reduced vibration behaviour of the printing unit. With this arrangement of the printing blankets, asymmetrical coinciding of adjacent clamping channels of adjacent rotary bodies of the printing unit only results in an asymmetrical vibration excitation, which on the whole results in less intensive vibration. Furthermore, this asymmetrical arrangement of the mounts offers the possibility of replacing the two adjacent rubber blankets, which are attached in a common clamping channel, with a double width rubber blanket in order to enable the super panorama print.

From the knowledge gained the inventors suggest to improve a printing unit of a reel-fed printing press with at least a cylinder pair, consisting of a transfer cylinder and a form cylinder interacting with the transfer cylinder, wherein the body length of the transfer cylinder and the form cylinder corresponds to six horizontal or upright print pages and the transfer cylinder has two channels which are offset by 180° in the circumferential direction to accommodate printing blankets and three printing blankets are arranged next to one another in the longitudinal direction of the transfer cylinder, such that two adjacent printing blankets are attached in a channel and the third printing blanket is attached in the channel arranged offset by 180° relative to this.

As a result of this structure of the printing unit and the asymmetrical arrangement of the three printing blankets with 0°-0°-180° or 180°-0°-0° and 180°-180°-0° or 0°-180°-180° offset the excitation and the tendency to vibration of the rotary bodies is reduced.

As an alternative to this, the inventors also suggest to improve a printing unit of a reel-fed printing press with at least a cylinder pair, consisting of a transfer cylinder and a form cylinder interacting with the transfer cylinder, wherein the body length of the transfer cylinder and the form cylinder corresponds to six horizontal or upright print pages and the transfer cylinder has two channels offset by 180° in the circumferential direction to accommodate printing blankets and two printing blankets are arranged next to each other in the longitudinal direction of the transfer cylinder, such that a printing blanket relative to the body length of the transfer cylinder is twice as wide as the second printing blanket and each of the printing blankets are attached in one of the two channels which are arranged offset by 180°.

With this printing unit, the reduced susceptibility to vibration is likewise exploited through the asymmetrical mount arrangement, while the printing of “super panorama”, which is more than two pages wide, is made possible in addition.

In an embodiment of the invention the printing blankets can be constructed in several layers. This structure makes it possible to use only one layer of a printing blanket for attachment in the gap of the clamping channel, as a result of which the gap in total can be constructed with a lesser gap width. For example, the printing blankets can have at least a carrier plate, a rubber coating and an insulation layer, wherein the insulation layer is arranged between the carrier plate and rubber coating or on the side of the carrier plate facing away from the rubber blanket coating. Here, the carrier plate is generally attached in the clamping channel. Here, the insulating layer helps in preventing that the heat, which is generated through the flexing work of the rubber coating during the rolling-off of the transfer cylinder on a further cylinder which is in contact with the transfer cylinder, being introduced into the transfer cylinder. Heat introduction into the transfer cylinder mostly results in longitudinal expansion for thermal reasons with bending-through of the transfer cylinder which in-turn has a negative effect with regard to the vibration behaviour.

It is advantageous if the channels of the transfer cylinder form a clamping gap on the cylindrical surface wherein the clamping gap has a gap width in the range from 1 to 4 mm. The smaller the clamping gap, the lower is the vibration excitation upon meeting of adjacent gaps of adjacent rotary bodies.

The form cylinder can have two channels offset by 180° in the circumferential direction and two printing plates in the circumferential direction. By bypassing a channel, only one printing plate can obviously be arranged in the circumferential direction as well.

To also enable printing of “super panorama” it is favorable if the form cylinder has at least a panorama printing plate in the longitudinal direction which is more than two print pages wide. In an advantageous embodiment, the transfer cylinder can have a circumference corresponding at least to one or two horizontal or upright print pages. Preferably the printing units of the printing press are designed as a 6-1 or 6-2 printing unit.

Likewise, the form cylinder can have a circumference which at least corresponds to two horizontal or upright print pages.

The circumferential ratio of the transfer cylinder to the form cylinder should be even-numbered, or both cylinders should have the same size circumferences.

To enable printing of one side of the sheet and reprinting the transfer cylinder can interact with a second transfer cylinder, wherein the printing material web is guided between the two transfer cylinders. However, construction as a satellite printing unit, where one or several transfer cylinders interact with one or several impression cylinders, is conceivable.

If several of these printing units are arranged together it is advantageous if, with adjacent printing units, the arrangement of the printing blankets on one printing unit is identical or dissymmetrical, relative to the center plane to the rotation axis of the form cylinders and transfer cylinders, to the arrangement of the printing blankets of the adjacent printing unit.

Preferred developments of the invention are obtained from the following description. Different exemplary embodiments of the invention, without being restricted to these, are explained in more detail by means of the drawings.

### BRIEF DESCRIPTION OF THE DRAWINGS

FIG. 1 is a lateral view of a printing unit with a six page wide cylinder pair; and

FIG. 2 is a lateral view of a further embodiment of a printing unit.

### DETAILED DESCRIPTION OF THE DRAWINGS

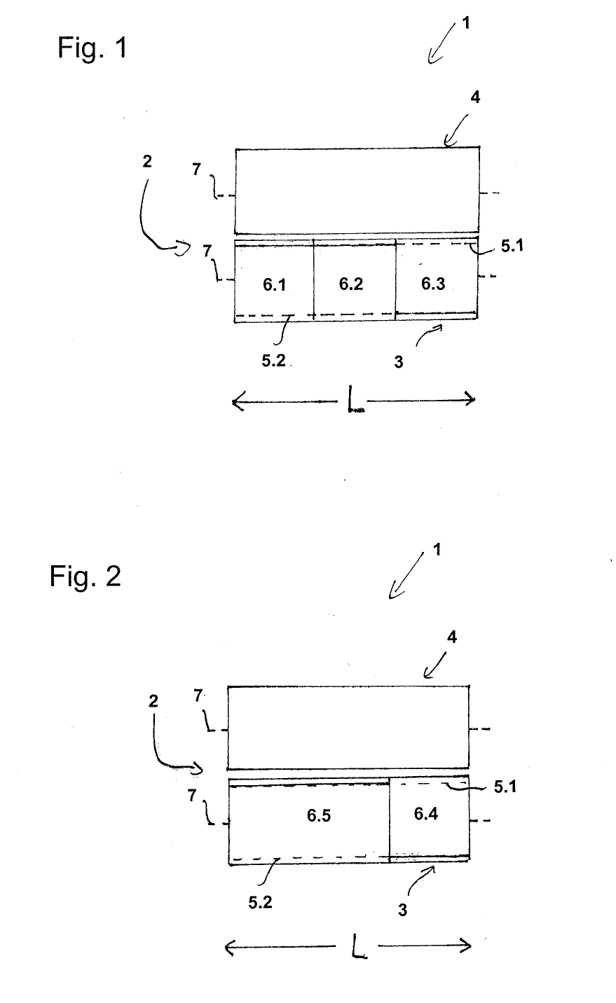

The present invention is described in the following with reference to FIGS. 1 and 2.

FIG. 1 shows a lateral view of a cylinder pair 2 of a printing unit 1, consisting of a form cylinder 4 and a transfer cylinder 3. Both cylinders 3, 4 each have a body length L which corresponds to six upright or horizontal print pages, preferably newspaper pages. In operation of the printing unit 1 the form cylinder 4 and the transfer cylinder 3 rotate around their rotation axes 7. The form cylinder 4 is shown without printing plates and without clamping device for the printing plates. The transfer cylinder 3 on its circumference has two channels 5.1 and 5.2 offset by 180° in which three printing blankets 6.1 to 6.3 are attached next to one another. The adjacent printing blankets 6.1 and 6.2 in this case are attached in a first channel 5.1, which is indicated by the continuous line of channel 5.1. The third printing blanket 6.3 is attached in the second channel 5.2 offset by 180° relative to this. In the sections in which no printing blanket is attached, namely the dashed lines of the channels 5.1 and 5.2, one or several filling bodies can be arranged in the clamping gap, which closes the gap in the cylindrical surface of the transfer cylinder 3 which results from the clamping gap. In operation of the printing unit 1, the clamping points, namely the left two-thirds of the first channel 5.1 which is used for the attachment of the printing blankets 6.1 and 6.2 alternately come in contact with the form cylinder 4 or with the clamping points of the form cylinder 4 not shown in FIG. 1. After this, with a 180° rotation, the right third of the second channel 5.2 comes in contact with the form cylinder 4 or its clamping channels. As explained at the outset, channel knocking occurs in the contact area between form cylinder 4 and transfer cylinder 3 because of the contact pressure of the cylinders 3 and 4 and the reduced resistance moment when the clamping points meet, which results in vibration excitation. Through the asymmetrical arrangement of the printing blankets 6.1 to 6.3 on the transfer cylinder 3, only asymmetrical excitation occurs which results either in reduced vibration than before or no vibration at all.

FIG. 2 shows a lateral view of a further embodiment of a printing unit 1. The printing unit 1 likewise consists of at least a cylinder pair 2, comprising a form cylinder 4 and a transfer cylinder 3. Both cylinders 3, 4 each have a body length L of six upright or horizontal print pages. In contrast with printing unit 1 from FIG. 1, only two printing blankets 6.4 and 6.5 are clamped to the transfer cylinder 3 in this printing unit 1. The printing blanket 6.5 on the left of the transfer cylinder 3 is double the width of the printing cloth 6.4 on the right relative to the body length L of the transfer cylinder. Through the asymmetrical distribution of the two printing blankets 6.4 and 6.5 on the transfer cylinder 3, asymmetrical excitation, which either results in reduced vibration than before or no vibration at all, likewise occurs. Furthermore, this special printing blanket arrangement of a double width printing blanket 6.5 and a single width printing blanket 6.4 enables panorama printing.

Only for completeness' sake is it pointed out that in FIG. 1 the two adjacent printing blankets 6.2 and 6.3 can also be attached in a common channel 5.1 or 5.2 and that the double width printing blanket 6.5 in FIG. 2 can also be arranged on the right on the transfer cylinder 3.

It is understood that the features mentioned above and the characteristics of the claims cannot only be used in the respective combinations stated but also in other combinations or on their own, without departing from the scope of the invention.

List of reference numbers:
1 Printing unit
2 Cylinder pair
3 Transfer cylinder
4 Form cylinder
5.1 First channel
5.2 Second channel
6.1 First printing blanket
6.2 Second printing blanket
6.3 Third printing blanket
6.4 Single width printing blanket
6.5 Double width printing blanket
7 Rotation axis
L Body length

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A printing unit of a rotary printing press, with at least a cylinder pair, consisting of a transfer cylinder and a form cylinder interacting with the transfer cylinder, wherein a body length of the transfer cylinder and the form cylinder corresponds to six horizontal or upright print pages and the transfer cylinder has two channels offset by 180° in a circumferential direction to accommodate printing blankets, wherein three printing blankets are arranged next to one another in a longitudinal direction of the transfer cylinder, and wherein two adjacent printing blankets are attached in one of the channels and the third printing blanket is attached in the other of the channels.

2. A printing unit of a rotary printing press, with at least a cylinder pair, consisting of a transfer cylinder and a form cylinder interacting with the transfer cylinder, wherein a body length of the transfer cylinder and the form cylinder corresponds to six horizontal or upright print pages and the transfer cylinder has two channels offset by 180° in a circumferential direction to accommodate printing blankets, wherein two printing blankets are arranged next to each other in a longitudinal direction of the transfer cylinder, and wherein one of the printing blankets relative to the body length of the transfer cylinder is twice as wide as the other printing blanket and the printing blankets each are attached in one of the two channels offset by 180°.

3. The printing unit according to claim 1, wherein the printing blankets are of a multiple layer structure.

4. The printing unit according to claim 3, wherein the printing blankets have at least a carrier plate, a rubber coating, and an insulating layer, and wherein the insulating layer is arranged between the carrier plate and the rubber coating or on a side of the carrier plate facing away from the rubber coating.

5. The printing unit according to claim 1, wherein the channels of the transfer cylinder form a clamping gap on a cylindrical surface wherein the clamping gap has a gap width in a range from 1 to 4 mm.

6. The printing unit according to claim 1, wherein the form cylinder has two channels offset by 180° in a circumferential direction and two printing plates in the circumferential direction.

7. The printing unit according to claim 6, wherein the form cylinder in a longitudinal direction has at least a panorama printing plate which is more than two print pages wide.

8. The printing unit according to claim 1, wherein the transfer cylinder has a circumference which corresponds to at least two horizontal or upright print pages.

9. The printing unit according to claim 1, wherein the form cylinder has a circumference which corresponds to at least one or two horizontal or upright print pages.

10. The printing unit according to claim 1, wherein a ratio of a circumference of the transfer cylinder to a circumference of the form cylinder is even-numbered or both circumferences are identical in size.

11. The printing unit according to claim 1, wherein the transfer cylinder interacts with a second transfer cylinder or an impression cylinder.

12. The printing unit according to claim 1, wherein at least two or more printing units are arranged, wherein with adjacent printing units an arrangement of the printing blankets of one of the printing units is identical to an arrangement of the printing blankets of the adjacent printing unit.

13. A printing unit of a rotary printing press, comprising:
a transfer cylinder; and
a form cylinder interacting with the transfer cylinder;
wherein the transfer cylinder has a first channel and a second channel and wherein the first channel is offset from the second channel by 180° in a circumferential direction;
wherein a first printing blanket is arranged adjacent to a second printing blanket in a longitudinal direction of the transfer cylinder and wherein the first and second printing blankets are attached in the first channel, and further wherein a third printing blanket is arranged in the longitudinal direction of the transfer cylinder and is attached in the second channel.

14. The printing unit according to claim 13, wherein the first and second channels each form a clamping gap on a cylindrical surface of the transfer cylinder and wherein the clamping gap has a gap width in a range from 1 to 4 mm.

15. The printing unit according to claim 14, wherein the printing blankets each include a carrier plate, a rubber coating, and an insulating layer, and wherein only the carrier plate of the printing blankets is attached in the respective channels.

16. The printing unit according to claim 13, further comprising a first and a second filling body arranged in a respective portion of the first and second channels that does not include a printing blanket.

17. A method for reducing vibration in a printing unit, comprising the steps of:
arranging a first printing blanket adjacent to a second printing blanket along a longitudinal axis of a transfer cylinder, wherein the first and second printing blankets are attached in a first channel of the transfer cylinder; and
arranging a third printing blanket along the longitudinal axis of the transfer cylinder, wherein the third printing blanket is attached in a second channel of the transfer cylinder;
wherein the first channel is offset from the second channel by 180° in a circumferential direction of the transfer cylinder.

18. The method according to claim 17, wherein the first and second channels each form a clamping gap on a cylindrical surface of the transfer cylinder and wherein the clamping gap has a gap width in a range from 1 to 4 mm.

19. The method according to claim 17, wherein the printing blankets each include a carrier plate, a rubber coating, and an insulating layer, and further comprising the step of attaching only the carrier plate of the printing blankets in the respective channels.

20. The method according to claim 17, further comprising the step of arranging a first and a second filling body in a respective portion of the first and second channels that does not include a printing blanket.
